(19) United States
(12) Patent Application Publication
(10) Pub. No.: US 2026/0135324 A1
(43) Pub. Date: May 14, 2026

(54) SHELL AND CONNECTOR

(71) Applicant: Yazaki Corporation, Tokyo (JP)

(72) Inventors: Tomoaki Hayakawa, Makinohara-shi (JP); Hideto Kumakura, Makinohara-shi (JP)

(21) Appl. No.: 19/384,204

(22) Filed: Nov. 10, 2025

(30) Foreign Application Priority Data
Nov. 11, 2024 (JP) 2024-196414

(51) Int. Cl. H01R 13/512

(52) U.S. Cl. CPC H01R 13/512

(57) ABSTRACT

A shell is used for being attached to a housing. The housing includes a terminal accommodating portion that accommodates a terminal, a conductive member accommodating portion that is disposed adjacent to the terminal accommodating portion so as to be immovable and accommodates a part of a conductive member extending from the terminal, and an opening that opens the terminal accommodating portion and the conductive member accommodating portion to an outside in a first intersecting direction intersecting an arrangement direction of the terminal accommodating portion and the conductive member accommodating portion. The shell includes: a first shell that covers at least a first opening corresponding to the terminal accommodating portion; and a second shell that covers at least a second opening corresponding to the conductive member accommodating portion. The first and second shells are rotatable relative to each other about an axis extending in the first intersecting direction.

### BACKGROUND OF THE INVENTION

### Field of the Invention

An embodiment of the present invention relates to a shell and a connector.

Priority is claimed on Japanese Patent Application No. 2024-196414 filed in Japan on Nov. 11, 2024, the content of which is incorporated herein by reference.

### Description of Related Art

A connector including a terminal, a housing that accommodates the terminal and a conductive member (a bus bar or an electric wire) extending from the terminal, and a shell that covers an opening of the housing is known. The opening of the housing is a portion of the housing that opens both an accommodating portion for the terminal (terminal accommodating portion) and an accommodating portion for the conductive member (conductive member accommodating portion) in the housing to the outside.

### PRIOR ART DOCUMENT

### Patent Document

Patent Document 1: Japanese Unexamined Patent Application, First Publication No. 2022-151014

### SUMMARY OF THE INVENTION

In such a type of connector, a direction of the conductive member extending from the terminal inside the housing (an extending direction of the conductive member) may change depending on an application. Due to such circumstances, a plurality of types of housings having different extending directions of the conductive member accommodating portion with respect to the terminal accommodating portion are prepared according to various applications of the connector. Hitherto, since a plurality of types of shells respectively corresponding to the plurality of types of housings are prepared, a manufacturing cost of the connector including the housing and the shell becomes high.

One embodiment provides a shell and a connector capable of reducing a manufacturing cost of the connector.

A shell according to one embodiment is a shell for being attached to a housing. The housing includes a terminal accommodating portion that accommodates a terminal, a conductive member accommodating portion that is disposed adjacent to the terminal accommodating portion so as to be immovable and accommodates a part of a conductive member extending from the terminal, and an opening that opens the terminal accommodating portion and the conductive member accommodating portion to an outside in a first intersecting direction intersecting an arrangement direction of the terminal accommodating portion and the conductive member accommodating portion. The shell includes: a first shell that covers, among the opening, at least a first opening corresponding to the terminal accommodating portion; and a second shell that covers, among the opening, at least a second opening corresponding to the conductive member accommodating portion. The first shell and the second shell are rotatable relative to each other about an axis extending in the first intersecting direction.

A connector according to one embodiment includes: a terminal; a housing including a terminal accommodating portion that accommodates the terminal, a conductive member accommodating portion that is disposed adjacent to the terminal accommodating portion so as to be immovable and accommodates a part of a conductive member extending from the terminal, and an opening that opens the terminal accommodating portion and the conductive member accommodating portion to an outside in a first intersecting direction intersecting an arrangement direction of the terminal accommodating portion and the conductive member accommodating portion; and the above-mentioned shell.

With the shell and the connector according to one embodiment of the present invention, the manufacturing cost of the connector can be reduced.

### BRIEF DESCRIPTION OF THE DRAWINGS

FIG. 1 is a perspective view of a routing unit including a connector according to one embodiment when viewed from a front side.

FIG. 2 is an exploded perspective view of a state in which a shell is detached from a housing in the connector according to one embodiment when viewed from the front side.

FIG. 3 is an exploded perspective view of a state in which the shell is detached from the housing in the connector according to one embodiment when viewed from a rear side.

FIG. 4 is a front view of the shell illustrated in FIGS. 2 and 3 when viewed from the front side.

FIG. 5 is a cross-sectional view taken along line V-V of FIG. 4.

FIG. 6 is a front view of a state in which a second shell is rotated by a predetermined angle with respect to a first shell in the shell illustrated in FIG. 4 when viewed from the front side.

FIG. 7 is a cross-sectional view illustrating a modified example of the connector according to one embodiment.

### DETAILED DESCRIPTION OF THE INVENTION

Hereinafter, embodiments will be described with reference to the drawings. In the following description, constitutions having the same or similar functions are denoted by the same reference numbers. Redundant descriptions of these constitutions may be omitted.

In the present disclosure, the terms are defined as follows. The term “connection” is not limited to a mechanical connection, and may include an electrical connection. Further, the term “connection” is not limited to a case where two elements that are connection targets are directly connected, and may include a case where two elements that are connection targets are connected with another element interposed therebetween.

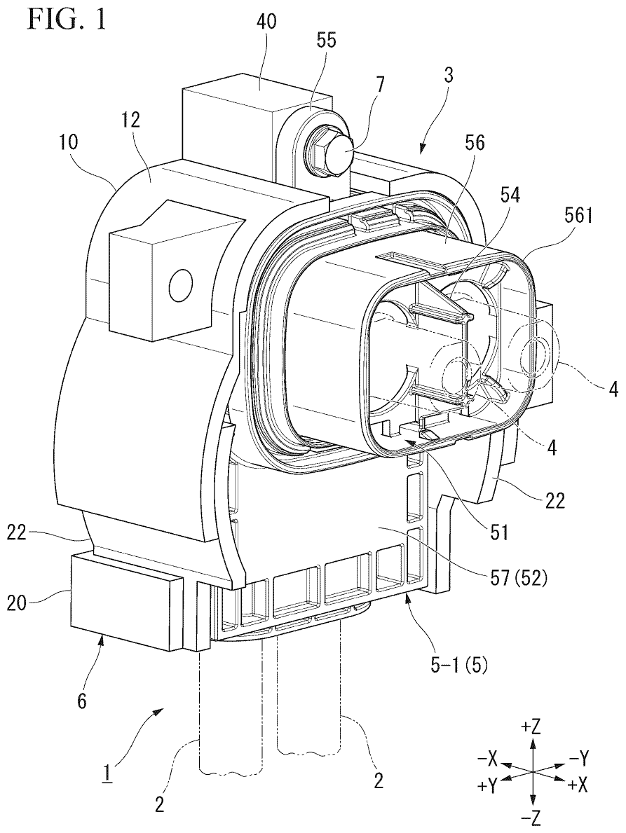

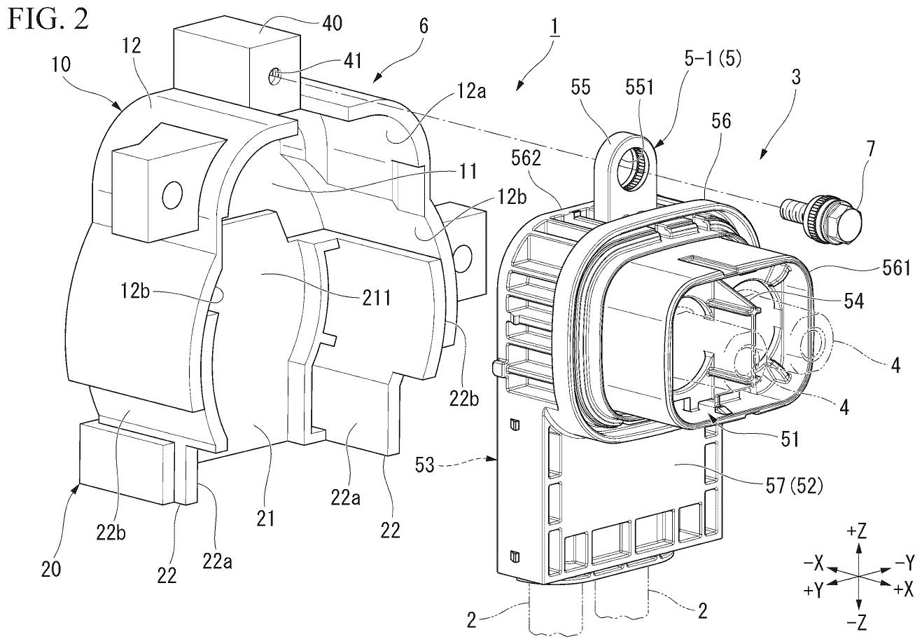

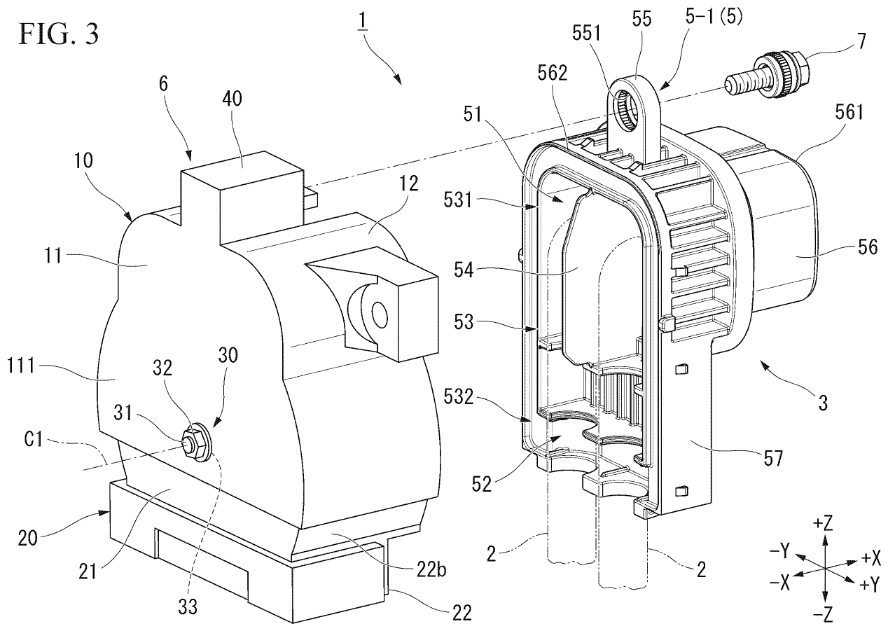

In the present disclosure, a +X direction, a −X direction, a +Y direction, a −Y direction, a +Z direction, and a −Z direction are defined as follows. The +X direction is a direction in which a shell 6 and a housing 5 of a connector 3 are arranged in order (see FIGS. 1 to 3). The −X direction is a direction opposite to the +X direction. When the +X direction and the −X direction are not distinguished from each other, they are simply referred to as “X direction”. The Y direction is a direction intersecting (for example, orthogonal to) the X direction. The +Y direction is a direction from one of two terminals 4 of the connector 3 to the other (See FIGS. 1 and 2). The −Y direction is a direction opposite to the +Y direction. When the +Y direction and the −Y direction are not distinguished from each other, they are simply referred to as “Y direction”. The +Z direction is a direction intersecting (for example, orthogonal to) the X direction and the Y direction. The +Z direction is a direction in which a conductive member accommodating portion 52 and a terminal accommodating portion 51 of the housing 5 are arranged in order (see FIG. 3). The −Z direction is a direction opposite to the +Z direction. When the +Z direction and the −Z direction are not distinguished from each other, they are simply referred to as “Z direction”. The Z direction is an example of an “arrangement direction of the terminal accommodating portion 51 and the conductive member accommodating portion 52”. The X direction is an example of a “first intersecting direction” intersecting the arrangement direction. In addition, hereinafter, for convenience of description, the +X-direction side may be referred to as a “front side”, and a −X-direction side may be referred to as a “rear side”.

### 1. Connector

As illustrated in FIGS. 1 to 3, the connector 3 of one embodiment is a component for electrically connecting an electric wire 2 to a mating connector (not illustrated). The connector 3 is, for example, a connector used for a vehicle such as an electric vehicle (EV), a hybrid electric vehicle (HEV), or a plug-in hybrid electric vehicle (PHEV). The connector 3 is, for example, a high-voltage connector in which a current of 100 V or higher flows. The connector 3 of the present embodiment is a connector corresponding to two electrodes. However, the connector 3 may be, for example, a connector corresponding to one electrode or a connector corresponding to three or more electrodes.

The connector 3 includes the terminal 4, the housing 5, and the shell 6. The connector 3 constitutes the routing unit 1 together with the electric wire 2 (conductive member) connected to the terminal 4 of the connector 3.

### 2. Terminal

The terminal 4 is accommodated in the terminal accommodating portion 51 of the housing 5 described below. In the connector 3 illustrated in FIGS. 1 to 3, two terminals 4 are arranged in the Y direction in the terminal accommodating portion 51. The number of terminals 4 in the connector 3 is not limited to two, and may be any number. In addition, the arrangement of the plurality of terminals 4 in the terminal accommodating portion 51 may be arbitrary.

### 3. Housing

As illustrated in FIGS. 2 and 3, the housing 5 is made of a material having an electrical insulation property (for example, a synthetic resin material). The housing 5 includes the terminal accommodating portion 51, the conductive member accommodating portion 52, an opening 53, an insulating wall 54, and an attaching portion 55.

### 4. Terminal Accommodating Portion

The terminal accommodating portion 51 is a space in the housing 5, the space accommodating the terminal 4 described above. The terminal accommodating portion 51 of the present embodiment is a space inside a tubular portion 56 extending in the X direction and having both ends opened. With such a configuration, the terminal accommodating portion 51 is opened to a first end 561 side of the tubular portion 56 positioned on the front side (+X direction side) and a second end 562 side of the tubular portion 56 positioned on the rear side (−X direction side).

A portion of the tubular portion 56 on the first end 561 side is a fitted portion to be fitted to the mating connector. The terminal 4 accommodated in the terminal accommodating portion 51 is exposed to the outside of the housing 5 through an opening of the tubular portion 56 on the first end 561 side. With such a configuration, the terminal 4 is connected to a terminal (not illustrated) of the mating connector in a state in which the portion of the tubular portion 56 on the first end 561 side is fitted to the mating connector.

An opening of the tubular portion 56 on the second end 562 side is a first opening 531 that opens the terminal accommodating portion 51 to the outside from the rear side (−X direction side).

### 5. Conductive Member Accommodating Portion

As illustrated in FIG. 3, the conductive member accommodating portion 52 (electric wire accommodating portion) is a space in the housing 5, the space accommodating a part of the electric wire 2 (conductive member) extending from the terminal 4 accommodated in the terminal accommodating portion 51. The conductive member accommodating portion 52 is disposed adjacent to the terminal accommodating portion 51 so as to be immovable. A proximal end portion of the electric wire 2, which is adjacent to the terminal 4, is accommodated in the conductive member accommodating portion 52, and a portion of the electric wire 2 that further extends from the proximal end portion is led out to the outside of the conductive member accommodating portion 52. In the following description, a direction in which the electric wire 2 extends in the conductive member accommodating portion 52 may be referred to as an “extending direction of the conductive member accommodating portion 52”.

The conductive member accommodating portion 52 of the present embodiment is a space inside a guide portion 57 that guides the electric wire 2 extending from the terminal 4 in a predetermined direction. The guide portion 57 is formed integrally with the tubular portion 56. That is, the tubular portion 56 and the guide portion 57 are fixed so as not to move relative to each other. The guide portion 57 is connected to a portion of the tubular portion 56 on the second end 562 side. With such a configuration, the conductive member accommodating portion 52 communicates with the terminal accommodating portion 51 on the second end 562 side of the tubular portion 56.

In the present embodiment, the guide portion 57 extends from the tubular portion 56 in a direction intersecting the X direction (for example, a direction orthogonal to the X direction). The guide portion 57 guides the electric wire 2 in a direction in which the guide portion 57 extends from the tubular portion 56. The extending direction of the guide portion 57 corresponds to the extending direction of the conductive member accommodating portion 52. In the housing 5 illustrated in FIG. 3, the guide portion 57 extends in the −Z direction with respect to the tubular portion 56. In the housing 5, for example, the guide portion 57 may extend obliquely toward a −Y direction side or a +Y direction side as it goes toward the −Z direction with respect to the tubular portion 56 when viewed from the X direction.

The guide portion 57 has a second opening 532 that opens the conductive member accommodating portion 52 to the outside of the housing 5 from the rear side (−X direction side).

The opening 53 of the housing 5 opens the terminal accommodating portion 51 and the conductive member accommodating portion 52 described above to the outside in the −X direction (first intersecting direction). The opening 53 includes the first opening 531 and the second opening 532 described above.

### 6. Insulating Wall

As illustrated in FIGS. 2 and 3, the insulating wall 54 is positioned between the adjacent terminals 4 in the terminal accommodating portion 51 to electrically insulate the adjacent terminals 4 from each other. Specifically, the insulating wall 54 is positioned between the terminals 4 adjacent to each other in the Y direction in the terminal accommodating portion 51. The insulating wall 54 is formed in a shape extending in the X direction and the Z direction with the Y direction as a thickness direction.

### 7. Attaching Portion

The attaching portion 55 is a portion of the housing 5 for fixing the shell 6 to the housing 5. In the present embodiment, the attaching portion 55 has an attachment hole 551 through which a shaft portion of an attachment bolt 7 used for attaching the shell 6 passes. The attaching portion 55 is positioned on the second end 562 side of the tubular portion 56 and protrudes from the tubular portion 56 in a direction intersecting the X direction (the +Z direction in the illustrated example). The attachment hole 551 penetrates through the attaching portion 55 in the X direction. In the present embodiment, the attaching portion 55 is formed integrally with the tubular portion 56 constituting the terminal accommodating portion 51 and is positioned away from the guide portion 57 constituting the conductive member accommodating portion 52.

### 8. Shell

As illustrated in FIG. 1, the shell 6 is attached to the housing 5 to cover the opening 53 (see FIG. 3) of the housing 5. As illustrated in FIGS. 1 and 3, the shell 6 includes a first shell 10, a second shell 20, a fixing portion 30, and an attached portion 40. The first shell 10 and the second shell 20 are made of a material having an electrical insulation property (for example, a synthetic resin material).

The first shell 10 covers, among the opening 53 of the housing 5, at least the first opening 531 (see FIG. 3) corresponding to the terminal accommodating portion 51. The second shell 20 covers, among the opening 53 of the housing 5, at least the second opening 532 (see FIG. 3) corresponding to the conductive member accommodating portion 52. As illustrated in FIG. 3, the first shell 10 and the second shell 20 are rotatable relative to each other about an axis C1 extending in the X direction (first intersecting direction). The fixing portion 30 unrotatably fixes the first shell 10 and the second shell 20 to each other. The fixing portion 30 fixes the first shell 10 and the second shell 20 to each other at an arbitrary rotational position.

Hereinafter, the configuration of the shell 6 of the present embodiment will be further described.

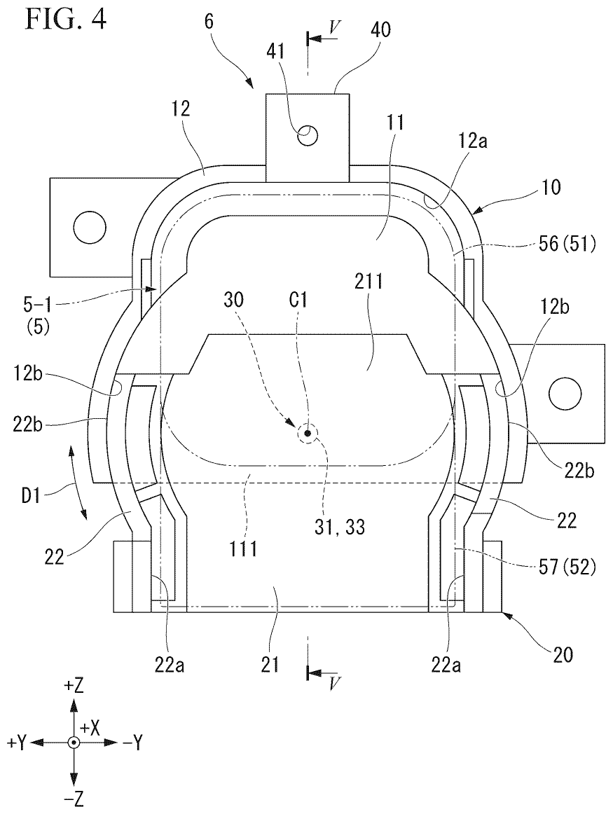

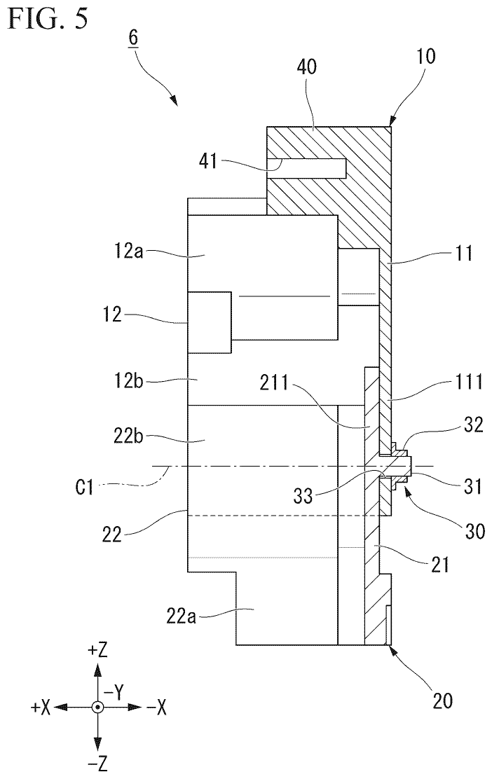

As illustrated in FIGS. 4 and 5, the first shell 10 and the second shell 20 are arranged in order in the −Z direction. A portion of the first shell 10 on a −Z direction side and a portion of the second shell 20 on a +Z direction side overlap each other.

### 9. First Shell

As illustrated in FIGS. 2, 4, and 5, the first shell 10 of the present embodiment includes a first cover portion 11 and a first side wall 12.

The first cover portion 11 is formed in a plate shape with the X direction as a plate thickness direction. The first cover portion 11 mainly covers the first opening 531 (see FIG. 3) of the tubular portion 56 (terminal accommodating portion 51). A portion of the first cover portion 11 on the-Z direction side is a first overlapping portion 111 overlapping a second cover portion 21 of the second shell 20 described below in the X direction.

The first side wall 12 extends in the +X direction (one side in the plate thickness direction of the first cover portion 11) from a part of a peripheral edge of the first cover portion 11. The first side wall 12 is positioned at a portion of the peripheral edge of the first cover portion 11 excluding an edge portion on the −Z direction side, which is adjacent to the second shell 20. In other words, an opening is formed at a portion of the first side wall 12 on the −Z direction side, the first side wall 12 being provided on the peripheral edge of the first cover portion 11.

As illustrated in FIGS. 2 and 4, the first side wall 12 has a first inner side surface 12a and an arc-shaped inner surface (arcuate inner surface) 12b.

The first inner side surface 12a is a surface that faces and covers a part of an outer periphery of the tubular portion 56 in a state in which the shell 6 is attached to the housing 5. In the present embodiment, the first inner side surface 12a is formed at a portion of the first side wall 12 on the +Z direction side. The first inner side surface 12a is formed in a recessed shape recessed toward the +Z direction side when viewed from the X direction.

The arc-shaped inner surface 12b is a surface centered on the axis C1 which is a relative rotation center between the first shell 10 and the second shell 20. In the present embodiment, the arc-shaped inner surface 12b is formed at a portion of the first side wall 12 adjacent to the first inner side surface 12a on the −Z direction side. Specifically, the arc-shaped inner surface 12b is formed to be continuous on the −Z direction side from each of both ends of the first inner side surface 12a having a recessed shape recessed toward the +Z direction side when viewed from the X direction. With such a configuration, the arc-shaped inner surface 12b is positioned at each of both ends of the first cover portion 11 in the Y direction. The two arc-shaped inner surfaces 12b face each other in the Y direction.

### 10. Second Shell

As illustrated in FIGS. 2, 4, and 5, the second shell 20 of the present embodiment includes the second cover portion 21 and a second side wall 22.

The second cover portion 21 is formed in a plate shape with the X direction as a plate thickness direction. The second cover portion 21 mainly covers the second opening 532 (see FIG. 3) of the guide portion 57 (conductive member accommodating portion 52). A portion of the second cover portion 21 on the +Z direction side is a second overlapping portion 211 overlapping the first cover portion 11 of the first shell 10 in the X direction. In the present embodiment, the second overlapping portion 211 overlaps the first overlapping portion 111 of the first cover portion 11 on the +X direction side (housing 5 side).

The second side wall 22 extends in the +X direction (one side in the plate thickness direction of the second cover portion 21) from a part of a peripheral edge of the second cover portion 21. The second side wall 22 is positioned only at an edge portion on each of both sides of the peripheral edge of the second cover portion 21 in the Y direction, and is not positioned at edge portions on both sides of the peripheral edge of the second cover portion 21 in the Z direction. In other words, openings are formed at portions of the second side wall 22 on the +Z direction side and the −Z direction side, the second side wall 22 being provided on the peripheral edge of the second cover portion 21.

An inner space of the first shell 10 and an inner space of the second shell 20 communicate with each other by forming the opening at the portion of the first side wall 12 on the −Z direction side and forming the opening at the portion of the second side wall 22 on the +Z direction side. In addition, since the opening is formed at the portion of the second side wall 22 on the −Z direction side, the electric wire 2 can be led out to the outside of the guide portion 57 (housing 5) even in a state in which the shell 6 is attached to the housing 5.

As illustrated in FIGS. 2 and 4, each of the two second side walls 22 has second inner side surfaces 22a and arc-shaped outer surfaces (arcuate outer surfaces) 22b.

The two second inner side surfaces 22a are surfaces facing outer surfaces of the guide portion 57 that face both sides in the Y direction in a state in which the shell 6 is attached to the housing 5. In the present embodiment, each of the second inner side surfaces 22a is formed at an end portion of each of the second side walls 22 on the −Z direction side.

Each of the two arc-shaped outer surfaces 22b is a surface centered on the axis C1. In the present embodiment, each arc-shaped outer surface 22b is formed at an end portion of the second side wall 22 on the +Z direction side. The arc-shaped outer surface 22b of the second side wall 22 is in surface contact with the arc-shaped inner surface 12b of the first side wall 12 in a state in which the second shell 20 is attached to the first shell 10. When the first shell 10 and the second shell 20 are relatively rotated about the axis C1, the arc-shaped inner surface 12b and the arc-shaped outer surface 22b slide in a circumferential direction D1 about the axis C1.

### 11. Fixing Portion

As illustrated in FIGS. 3 to 5, the fixing portion 30 includes a bolt 31, a nut 32, and an insertion hole 33.

The bolt 31 is attached to the first shell 10 and the second shell 20 and disposed on the axis C1. In the present embodiment, the bolt 31 is a male screw portion provided integrally with the second shell 20. Specifically, the bolt 31 protrudes from a surface of the second overlapping portion 211 of the second cover portion 21 constituting the second shell 20, the surface facing the first overlapping portion 111 of the first cover portion 11.

The insertion hole 33 is formed in the first shell 10, and the bolt 31 (male screw portion) is inserted through the insertion hole 33. Specifically, the insertion hole 33 is formed in the first overlapping portion 111 of the first cover portion 11 and penetrates through the first overlapping portion 111 in a plate thickness direction of the first overlapping portion 111.

The nut 32 is screwed to the bolt 31 attached to the first shell 10 and the second shell 20 to unrotatably fix the first shell 10 and the second shell 20 to each other. Specifically, the nut 32 is screwed to a distal end portion of the bolt 31 inserted through the insertion hole 33 of the second shell 20 to sandwich the first shell 10 (first cover portion 11) with the second shell 20 (second cover portion 21). By sandwiching the first shell 10 between the nut 32 and the second shell 20, the first shell 10 and the second shell 20 are relatively unrotatably fixed.

### 12. Attached Portion

As illustrated in FIGS. 1 to 3, the attached portion 40 is a portion of the shell 6 for fixing the shell 6 to the housing 5. The attached portion 40 is adjacent to the attaching portion 55 of the housing 5 on the −X direction side in a state in which the shell 6 is attached to the housing 5. In the present embodiment, the attached portion 40 includes a female screw 41 to which the shaft portion of the attachment bolt 7 is screwed. The attached portion 40 is integrally formed with the first shell 10. The attached portion 40 protrudes in a direction (the +Z direction in the illustrated example) intersecting the X direction from an outer surface of the first side wall 12 of the first shell 10.

Since the shell 6 includes the attached portion 40 described above, the shell 6 can be fixed to the housing 5 as follows. First, the shell 6 is attached to the housing 5, and the attached portion 40 of the shell 6 is disposed adjacent to the attaching portion 55 of the housing 5 on the −X direction side. Thereafter, the shaft portion of the attachment bolt 7 passes through the attachment hole 551 of the attaching portion 55 and then is screwed to the female screw of the attached portion 40, whereby the attached portion 40 of the shell 6 is fixed to the attaching portion 55 of the housing 5. The shell 6 is fixed to the housing 5 by fixing the attached portion 40 to the attaching portion 55.

### 13. Advantages

According to the present embodiment, the shell 6 covering the opening 53 of the housing 5 includes the first shell 10 that covers at least the first opening 531 corresponding to the terminal accommodating portion 51 in the opening 53 and the second shell 20 that covers at least the second opening 532 corresponding to the conductive member accommodating portion 52 in the opening 53. The first shell 10 and the second shell 20 are rotatable relative to each other about the axis C1 extending in the X direction (first intersecting direction). That is, a direction in which the second shell 20 corresponding to the conductive member accommodating portion 52 extends with respect to the first shell 10 corresponding to the terminal accommodating portion 51 can be changed.

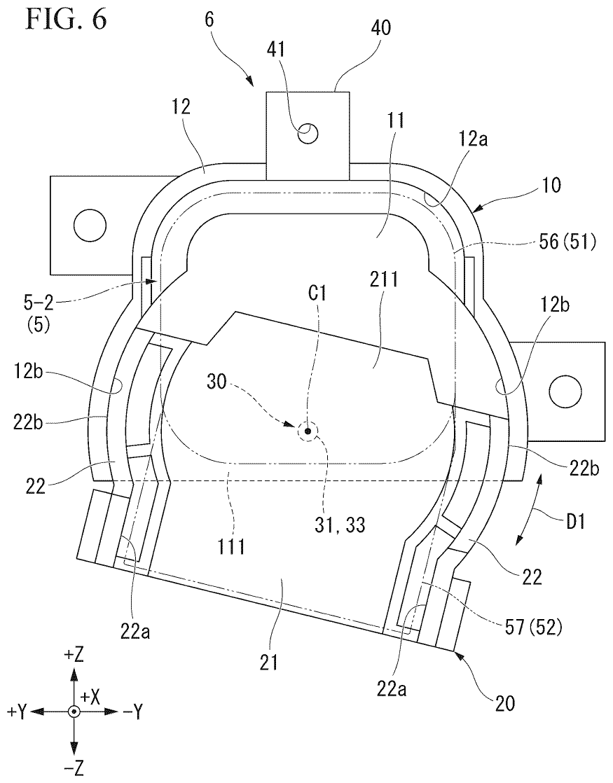

With such a configuration, it is possible to attach the same type of shell 6 to a plurality of types of housings 5 having different extending directions of the conductive member accommodating portion 52 with respect to the terminal accommodating portion 51. For example, the same type of shell 6 can be attached to a housing 5-1 of a first example illustrated in FIGS. 1 to 4 and a housing 5-2 of a second example illustrated in FIG. 6. This point will be described below.

As illustrated in FIG. 4, in the housing 5-1 of the first example, the guide portion 57 including the conductive member accommodating portion 52 extends in the-Z direction with respect to the tubular portion 56 including the terminal accommodating portion 51. In order to attach the shell 6 to the housing 5-1 of the first example, the relative rotational position between the first shell 10 and the second shell 20 is set such that the second shell 20 extends in the-Z direction with respect to the first shell 10. By setting the relative rotational position between the first shell 10 and the second shell 20 in this manner, the shell 6 can be attached to the housing 5-1 of the first example.

On the other hand, as illustrated in FIG. 6, in the housing 5-2 of the second example, the guide portion 57 including the conductive member accommodating portion 52 extends in an inclined direction inclined toward the +Y direction side as it goes toward the-Z direction with respect to the tubular portion 56 including the terminal accommodating portion 51. In order to attach the shell 6 to the housing 5-2 of the second example, the relative rotational position between the first shell 10 and the second shell 20 is set such that the second shell 20 extends in the above-described “inclined direction” with respect to the first shell 10. By setting the relative rotational position between the first shell 10 and the second shell 20 in this manner, the shell 6 can be attached to the housing 5-2 of the second example.

As described above, since the same type of shell 6 is compatible with various types of housings 5, versatility of the shell 6 can be improved. Therefore, a manufacturing cost of the connector 3 including the housing 5 and the shell 6 can be reduced.

According to the present embodiment, the shell 6 further includes the fixing portion 30 that unrotatably fixes the first shell 10 and the second shell 20 to each other.

With such a configuration, the shell 6 can be easily attached to the housing 5 in a state in which the first shell 10 and the second shell 20 are held at desired rotational positions by the fixing portion 30.

According to the present embodiment, the fixing portion 30 of the shell 6 includes the bolt 31 attached to the first shell 10 and the second shell 20 and disposed on the axis C1, and the nut 32 screwed to the bolt 31 to unrotatably fix the first shell 10 and the second shell 20 to each other. In such a configuration, the first shell 10 and the second shell 20 can be reliably unrotatably fixed to each other by the fixing portion 30. In addition, since the bolt 31 is attached to the first shell 10 and the second shell 20 and disposed on the axis C1, the first shell 10 and the second shell 20 can be relatively rotated about the axis C1 by the bolt 31. In other words, the bolt 31 of the fixing portion 30 can also have a function of making the first shell 10 and the second shell 20 relatively rotatable.

According to the present embodiment, the bolt 31 is a male screw portion provided integrally with the second shell 20. The fixing portion 30 includes the insertion hole 33 which is formed in the first shell 10 and positioned on the axis C1 and through which the bolt 31 (male screw portion) is inserted.

With such a configuration, the first shell 10 and the second shell 20 can be relatively rotated about the axis C1 only by inserting the bolt 31 provided in the second shell 20 through the insertion hole 33 of the first shell 10. In addition, since the bolt 31 is provided integrally with the second shell 20, the number of components of the shell 6 can be reduced as compared with a case where the bolt 31 is separate from the first shell 10 and the second shell 20.

According to the present embodiment, the first shell 10 has the arc-shaped inner surface 12b centered on the axis C1, and the second shell 20 has the arc-shaped outer surface 22b centered on the axis C1. The arc-shaped inner surface 12b and the arc-shaped outer surface 22b come into surface contact with each other and slide in the circumferential direction D1 about the axis C1.

With such a configuration, the first shell 10 and the second shell 20 can be relatively rotated smoothly and stably. In addition, relative rattling between the first shell 10 and the second shell 20 can be suppressed or prevented, and the integrity and strength of the entire shell 6 can be secured.

Further, since the arc-shaped inner surface 12b and the arc-shaped outer surface 22b are in surface contact with each other, it is possible to suppress or prevent generation of a gap between the first shell 10 and the second shell 20 regardless of the relative rotational position between the first shell 10 and the second shell 20. As a result, it is possible to suppress or prevent the terminal accommodating portion 51 and the conductive member accommodating portion 52 of the housing 5 from communicating with the outside due to the gap between the first shell 10 and the second shell 20.

### 14. Modified Example

In the above-described embodiment, the first shell 10 has the arc-shaped inner surface 12b centered on the axis C1, and the second shell 20 has the arc-shaped outer surface 22b centered on the axis C1. However, for example, the first shell 10 may have an arc-shaped outer surface, and the second shell 20 may have an arc-shaped inner surface. It is sufficient if the arc-shaped outer surface and the arc-shaped inner surface come into surface contact with each other and slide in the circumferential direction D1 about the axis C1. Even with such a configuration, the same effects as those of the above-described embodiment are obtained.

In the above-described embodiment, the first side wall 12 of the first shell 10 has the first inner side surface 12a. However, the first side wall 12 does not have to have the first inner side surface 12a, for example.

In the above-described embodiment, the first shell 10 includes the first cover portion 11 and the first side wall 12. However, the first shell 10 only needs to include at least the first cover portion 11, and does not have to include, for example, the first side wall 12.

In the above-described embodiment, the second side wall 22 of the second shell 20 has the second inner side surface 22a. However, the second side wall 22 does not have to have the second inner side surface 22a, for example.

In the above-described embodiment, the second shell 20 includes the second cover portion 21 and the second side wall 22. However, the second shell 20 only needs to include at least the second cover portion 21, and does not have to include the second side wall 22, for example.

In the above-described embodiment, the electric wire 2 is directly connected to the terminal 4 of the connector 3. However, the electric wire 2 does not have to be directly connected to the terminal 4 of the connector 3. For example, a bus bar (conductive member) may be connected to the terminal 4 of the connector 3, and the electric wire 2 may be connected to the terminal 4 via the bus bar. In this case, only the bus bar may be accommodated in the conductive member accommodating portion 52 of the housing 5, or the bus bar and a part of the electric wire 2 connected thereto may be accommodated in the conductive member accommodating portion 52 of the housing 5.

In the above-described embodiment, the bolt 31 of the fixing portion 30 disposed on the axis C1 may be a male screw portion provided integrally with the second shell 20. However, the bolt 31 may be, for example, a male screw portion provided integrally with the first shell 10. Specifically, the bolt 31 (male screw portion) may protrude from, for example, a surface of the first overlapping portion 111 of the first cover portion 11 constituting the first shell 10, the surface facing the second overlapping portion 211 of the second cover portion 21. In this case, the insertion hole 33 through which the bolt 31 is inserted may be formed in the second shell 20. Specifically, it is sufficient if the insertion hole 33 is formed in the second overlapping portion 211 of the second cover portion 21 constituting the second shell 20 and penetrates through the second overlapping portion 211 in the plate thickness direction of the second overlapping portion 211. Even with such a configuration, the same effects as those of the above-described embodiment are obtained.

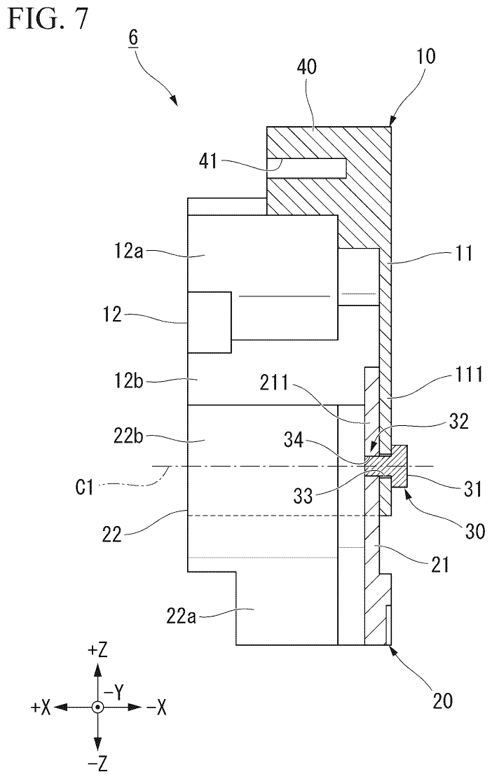

In addition, as illustrated in FIG. 7, for example, the bolt 31 of the fixing portion 30 disposed on the axis C1 may be provided separately from the first shell 10 and the second shell 20, and may be attached to the first shell 10 and the second shell 20 and disposed on the axis C1 by being inserted into holes 33 and 34 formed in both the first shell 10 and the second shell 20. In FIG. 7, the bolt 31 is inserted through the insertion hole 33 formed in the first shell 10 and the insertion hole 34 formed in the second shell 20. In this case, it is sufficient if the first and second shells 10 and 20 (first and second cover portions 11 and 21) are sandwiched between a head of the bolt 31 and the nut 32 by screwing the nut 32 to the distal end portion of the shaft portion of the bolt 31 inserted through the insertion holes 33 and 34 of the first and second shells 10 and 20. In such a configuration, the nut 32 screwed to the bolt 31 may be separate from the first shell 10 and the second shell 20, or may be provided integrally with one of the first shell 10 and the second shell 20.

In FIG. 7, the nut 32 is provided integrally with the second shell 20. The nut 32 integrated with the second shell 20 is a female screw portion formed on an inner periphery of the insertion hole 34 of the second shell 20. Therefore, the first shell 10 (first cover portion 11) is sandwiched between the head of the bolt 31 and the nut 32 (female screw portion). The hole 34 in which the female screw portion serving as the nut 32 is formed does not have to penetrate through the second shell 20, for example; namely, it may be a bottomed hole. Even with such a configuration, the same effects as those of the above-described embodiment are obtained.

A configuration in which the nut 32 (female screw portion) is provided integrally with the first shell 10 or the second shell 20 has an advantage that the manufacturing cost can be reduced as compared with a configuration in which the bolt 31 is provided integrally with the first shell 10 or the second shell 20.

One embodiment and modified examples have been described above. However, the embodiment and the modified examples are not limited to the examples described above. For example, the embodiment and the modified examples may be implemented in combination with each other.

### REFERENCE SIGNS LIST

2 Electric wire (conductive member)
3 Connector
4 Terminal
5 Housing
6 Shell
10 First shell
12b Arc-shaped inner surface
20 Second shell
22b Arc-shaped outer surface
30 Fixing portion
31 Bolt
32 Nut
33 Insertion hole
51 Terminal accommodating portion
52 Conductive member accommodating portion
53 Opening
531 First opening
532 Second opening
C1 Axis
D1 Circumferential direction

What is claimed is:

1. A shell for being attached to a housing, the housing including a terminal accommodating portion that accommodates a terminal, a conductive member accommodating portion that is disposed adjacent to the terminal accommodating portion so as to be immovable and accommodates a part of a conductive member extending from the terminal, and an opening that opens the terminal accommodating portion and the conductive member accommodating portion to an outside in a first intersecting direction intersecting an arrangement direction of the terminal accommodating portion and the conductive member accommodating portion, the shell comprising:
a first shell that covers, among the opening, at least a first opening corresponding to the terminal accommodating portion; and
a second shell that covers, among the opening, at least a second opening corresponding to the conductive member accommodating portion,
wherein the first shell and the second shell are rotatable relative to each other about an axis extending in the first intersecting direction.

2. The shell according to claim 1, further comprising a fixing portion that unrotatably fixes the first shell and the second shell to each other.

3. The shell according to claim 2,
wherein the fixing portion includes:
a bolt that is attached to the first shell and the second shell and disposed on the axis; and
a nut that unrotatably fixes the first shell and the second shell to each other by being screwed to the bolt.

4. The shell according to claim 3,
wherein the bolt is a male screw portion provided integrally with one of the first shell and the second shell, and
wherein the fixing portion has an insertion hole which is formed in the other one of the first shell and the second shell and is positioned on the axis, and through which the male screw portion is inserted.

5. The shell according to claim 3,
wherein the nut is a female screw portion provided integrally with the second shell,
wherein the fixing portion has an insertion hole which is formed in the first shell and is positioned on the axis, and through which the bolt is inserted, and
wherein the bolt is inserted through the insertion hole and is screwed to the female screw portion.

6. The shell according to claim 1,
wherein one of the first shell and the second shell has an arc-shaped inner surface centered on the axis,
wherein the other one of the first shell and the second shell has an arc-shaped outer surface centered on the axis, and
wherein the arc-shaped inner surface and the arc-shaped outer surface come into surface contact with each other and slide in a circumferential direction around the axis.

7. A connector comprising:
a terminal;
a housing including a terminal accommodating portion that accommodates the terminal, a conductive member accommodating portion that is disposed adjacent to the terminal accommodating portion so as to be immovable and accommodates a part of a conductive member extending from the terminal, and an opening that opens the terminal accommodating portion and the conductive member accommodating portion to an outside in a first intersecting direction intersecting an arrangement direction of the terminal accommodating portion and the conductive member accommodating portion; and
the shell according to claim 1.
